(19) United States
(12) Patent Application Publication
(10) Pub. No.: US 2016/0035360 A1
(43) Pub. Date: Feb. 4, 2016

(54) Method and Means of Encoding Background Noise Information

(71) Applicant: Unify GmbH & Co. KG, Munich (DE)

(72) Inventors: Herve Taddei, Bonn (DE); Stefan Schandl, Wien (AT); Panji Setiawan, Munchen (DE)

(21) Appl. No.: 14/880,490

(22) Filed: Oct. 12, 2015

Related U.S. Application Data
(63) Continuation of application No. 12/867,969, filed on Aug. 17, 2010.

(30) Foreign Application Priority Data
Feb. 19, 2008 (DE) 102008009719.5

(51) Int. Cl. G10L 19/012; G10L 19/02; G10L 19/24

(52) U.S. Cl. CPC G10L 19/012; G10L 19/24; G10L 19/0204

(57) ABSTRACT

The invention relates to a method and means for encoding background noise information during voice signal encoding methods. A basic idea of the invention is to provide the scalability known for transmitting voice information in a similar manner when forming an SID frame. The invention provides encoding of a narrowband first component and of a broadband second component of a piece of background noise information and formation of an SID frame which describes the background noise with separate areas for the first and second components.

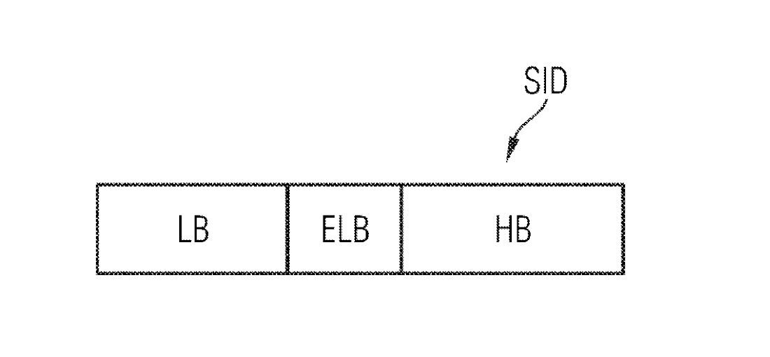

### CROSS-REFERENCE TO RELATED APPLICATIONS

This application is the United States national phase under 35 U.S.C. §371 of International Application No. PCT/EP2009/051118, filed on Feb. 2, 2009, and claiming priority to German Patent Application No. 10 2008 009 719.5, filed on Feb. 19, 2008. Both of those applications are incorporated by reference herein.

### BACKGROUND OF THE INVENTION

1. Field of the Invention

Embodiments relate to encoding background noise information in voice signal encoding methods.

2. Description of the Related Art

Since the beginnings of telecommunication, a limitation of bandwidth for analog voice transmission has been designated for telephone calls. Voice transmission takes place at a limited frequency range of 300 Hz to 3400 Hz.

Such a limited range of frequencies is also designated in many voice signal encoding methods for present-day digital telecommunications. To this end, prior to any encoding procedure, the analog signal's bandwidth is delimited. In the process, a codec is used for coding and decoding, which, because of the described delimitation of its bandwidth between 300 Hz and 3400 Hz, is also referred to as a narrowband speech codec in the following text. The term codec is understood to mean both the coding requirement for digital coding of audio signals and the decoding requirement for decoding data with the goal of reconstructing the audio signal.

One example of a narrowband speech codec is known as the ITU-T Standard G.729. Transmission of a narrowband speech signal having a bit rate of 8 kbits/s is possible using the coding requirement described therein.

Moreover, so-called wideband speech codecs are known, which provide encoding in an expanded frequency range for the purpose of improving the auditory impression. Such an expanded frequency range lies, for example, between a frequency of 50 Hz and 7000 Hz. One example of a wideband speech codec is known as the ITU-T Standard G.729.EV.

Customarily, encoding methods for wideband speech codecs are configured so as to be scalable. Scalability is here taken to mean that the transmitted encoded data contain various delimited blocks, which contain the narrowband component, the wideband component, and/or the full bandwidth of the encoded speech signal. Such a scalable configuration, on the one hand, allows downward compatibility on the part of the recipient and, on the other hand, in the case of limited data transmission capacities in the transmission channel, makes it easy for the sender and recipient to adjust the bit rate and the size of transmitted data frames.

To reduce the data transmission rate by means of a codec, customarily the data to be transmitted are compressed. Compression is achieved, for example, by encoding methods in which parameters for an excitation signal and filter parameters are specified for encoding the speech data. The filter parameters as well as the parameter that specifies the excitation signal are then transmitted to the recipient. There, with the aid of the codec, a synthetic speech signal is synthesized, which resembles the original speech signal as closely as possible in terms of a subjective auditory impression. With the aid of this method, which is also referred to as the “analysis by synthesis” method, the samples that are established and digitized are not transmitted themselves, but rather the parameters that were ascertained, which render a synthesis of the speech signal possible on the recipient's side.

A method for discontinuous transmission, which is also known in the field as DTX, affords an additional way to reduce the data transmission rate. The fundamental goal of DTX is to reduce the data transmission rate when there is a pause in speaking.

To this end, the sender employs speech pause recognition (Voice Activity Detection, VAD), which recognizes a speech pause if a certain signal level is not met. Customarily, the recipient does not expect complete silence during a speech pause. On the contrary, complete silence would lead to annoyance on the recipient's part or even to the suspicion that the connection had been interrupted. For this reason, methods are employed to produce a so-called comfort noise.

A comfort noise is a noise synthesized to fill phases of silence on the recipient's side. The comfort noise serves to foster a subjective impression of a connection that continues to exist without requiring the data transmission rate that is used for the purpose of transmitting speech signals. In other words, less energy is expended for the sender to encode the noise than to encode the speech data. To synthesize the comfort noise in a manner still perceived by the recipient as realistic, data are transmitted at a far lower bit rate. The data transmitted in the process are also referred to within the field as SID (Silence Insertion Descriptor).

Codecs presently in development focus on scalable encoding of speech information. By means of a scalable approach, the result of an encoding process is achieved that contains different blocks which contain the narrowband component of the original speech signal, the wideband component, or also contain the full bandwidth of the speech signal, that is, in the frequency range between 50 Hz and 7000 Hz, for example.

In the present scalable encoding method, the encoding of background noise information occurs either over the entire bandwidth of the input noise signal or over a section of the bandwidth of the input noise signal. The encoded noise signal is transmitted from SID frames by means of the DTX method and reconstructed on the receiver's side. The reconstructed, i.e., synthesized, comfort noise may then have a different quality than the synthesized speech information on the receiver's side. This negatively impacts the receiver's reception.

### BRIEF SUMMARY OF THE INVENTION

Embodiments of the invention may provide an improved implementation of the DTX method in scalable speech codecs.

Further embodiments may provide known scalability similar to the form of an SID frame for the transmission of voice information.

One method for encoding an SID frame for transmission of background noise information in the application of a scalable voice encoding method provides for encoding of a narrowband component of the background noise information first and a wideband component second. The encoding is customarily simultaneous and takes place in different ways. However, the encoding of a component can obviously also take place staggered in time before or after the encoding of another component. In addition, both components can optionally be encoded in the same way. After both components are encoded, an SID frame is formed with separate areas for the first and second components. In other words, in the SID frame, a first data area records the data for the encoded first component, while a separate data area records data for the second encoded component.

An important advantage of embodiments of the invention is that it is specified, on the receiver's side, whether comfort noise should occur based on the wideband component of the transmitted SID frame or on the narrowband component. This is a particular advantage for acoustic reception on the receiver's end in a situation in which the transmission rate for speech information frames is decreased such that only narrowband voice information is transmitted. If narrowband speech information is synthesized in combination with wideband noise, as in the current state of the art, this is very annoying to the receiver. The aforementioned decrease of the transmission rate for speech information frames can be caused by high utilization (congestion) of the network between the sender and receiver, for example. The significantly smaller SID frames are not affected by such a network bottleneck. Thus, for them, there is no constraint to reduce either their data transmission rate or their content.

According to a further advantageous embodiment of the invention, a third component is provided in the definition of the SID frame. This contains encoded background noise parameters which are encoded with a higher bit rate, although the third component still contains narrowband data (expanded narrowband or “Enhanced Low Band” data). The advantage of a definition of the SID frame with this third component lies in the ability to render a noise signal of increased quality in comparison to conventional narrowband encoding and thereby still remain in conformance with Standard G.729.B.

An embodiment example with additional advantages and configurations of the invention is illustrated in greater detail in the following by means of the drawing.

### BRIEF DESCRIPTION OF THE DRAWING

The FIGURE shows a structure of SID frame according to the invention.

### DETAILED DESCRIPTION OF THE INVENTION

In the following, the technical background underlying the invention is described in greater detail, initially without reference to the drawing.

Discontinuous transmission (DTX) methods implemented in current scalable encoding methods for wideband speech codecs do not currently support the scalability feature for transmission of background noise information, which is intended for the transmission of speech information.

As a current workaround, encoding takes place either over the entire bandwidth of an input noise signal or over a section of the bandwidth of the input noise signal.

In the past, two main types of speech codecs were developed: on the one hand, narrowband speech codecs such as 3GPP AMR, ITU-T G.729, for example, and on the other hand wideband speech codecs, such as 3GPP AMR-WB, ITU-T G.722, for example. A narrowband speech codec encodes speech signals with a sampling rate of 8 kHz with a bandwidth which customarily has a frequency range lying between 300 Hz and 3400 Hz. A wideband speech codec encodes a speech signal with 15 of a sampling rate of 16 kHz in a bandwidth in a frequency range between 50 Hz and 7000 Hz.

Some of these codecs use DTX methods, i.e., discontinuous transmission methods, in order to reduce the total transmission rate in the communication channel. According to the DTX method, SID frames are sent where the bandwidth of the SID frame corresponds to the bandwidth of the speech signal. The background noise during a speech pause is described in an SID frame.

Codecs currently in development focus on scalable encoding. With the aid of a scalable approach, an encoding process outcome is achieved that contains different blocks which contain the narrowband component of the original speech signal, the wideband component, or also the complete bandwidth of the speech signal, which is a frequency range between 50 Hz and 7000 Hz, for example. The wideband component customarily begins at a frequency of 4 kHz.

The existing DTX method does not currently support the scalable nature of codecs. Instead, encoding occurs either over the entire bandwidth of the input speech signal or over a section of the bandwidth of the input speech signal.

For clarification, the encoding method according to ITU-T Standard G.729.1 is described. This codec G.729.1 is a scalable speech codec in which the present non-scalable DTX method is applied to the entire bandwidth.

The encoding process during an active speech period—as opposed to a “Silent Period” identified speech pause—can be as follows:

The speech signal is separated into two components, namely a narrowband (Low Band) portion and a wideband (High Band) portion. Both signals are sampled at a sampling rate of 8 kHz. Partitioning into a narrowband and a wideband component takes place in a special band-pass filter, which is also called QMF (Quadrature Mirror Filter).

The narrowband component of the speech signal is encoded with a bit rate of 8 and 12 kbit/s. A CELP (Code Excited Linear Prediction) process is used for encoding of the speech signal. For bit rates above 14 kbit/s, the narrowband component is further modified in consideration of the “Transform Codec” section of G.729.1. The wideband component of the current frame—again on condition that this contains speech signals—is encoded at a bit rate of 14 kbit/s by applying the TDBWE (Time Domain Bandwidth Extension) method. For a bit rate above 14 kbit/s, the transform codec section of G.729.1 is applied.

The Standard G.729.1 does not provide a method for discontinuous transmission, so in speech pauses or “non-active voice periods”, a workaround is applied which is described in the following.

The speech signal is deconstructed into a narrowband and a wideband component, where both components are sampled at a frequency of 8 kHz. Decomposition takes place through a QMF filter as well.

The narrowband component is encoded by use of narrowband SID information. This narrowband SID information is sent to the receiver at a later point in time in an SID frame, which is compatible with Standard G.729. Additional measures as described above can contribute to an enhancement of the narrowband SID component.

The wideband component is encoded by applying a modified TDBWE method. During the so-called hangover periods, the speech signal is encoded at a bit rate of 14 kbit/s on top of that, while the speech pause of detected background noise is simultaneously analyzed and corresponding parameters are adjusted. The background noise is analyzed in terms of the energy of the noise signal and its frequency distribution. In contrast to the TDBWE methods provided by Standard G.729.1, the temporal fine structure is not analyzed; rather only an average of the energy over the frame is generated.

In the following, an embodiment of the invented method is explained based on the FIGURE.

The FIGURE shows an SID frame with separate areas for a narrowband first component LB (Low Band), a wideband second component HB (High Band) and an intermediate third component ELB (Enhanced Low Band).

The first component LB contains background noise parameters encoded with it, which are encoded at a bit rate of 8 kbit/s or lower. The data length of the first component LB is 15 bits, for example.

The second component HB contains encoded background noise parameters, which are encoded with a bit rate between 14 kbit/s and 32 kbit/s. The data length of the second component HB is 19 bits, for example.

The third component ELB contains encoded background noise parameters which are encoded at a bit rate of more than 8 kbit/s, such as 12 kbit/s for example. The data length of the third component ELB is 9 bits, for example. The advantage of a definition of the SID frame with a third component ELB consists of an option to render a noise signal of increased quality in comparison to conventional narrowband encoding methods while still remaining in conformance with Standard G.729.B.

During a speech pause, the characteristics of the background nose are acquired on the side of the encoder. The characteristics include the temporal distribution in particular as well as the spectral form of the background noise. For the acquisition process, a filter process is applied which considers the temporal and spectral parameters of the background noise from the previous frame. If significant changes in the character or in the strength of the background noise are revealed, a decision is made on the basis of threshold parameters (Threshold Values) about whether the acquired parameters need to be updated.

The following process is performed on the decoder or receiver side: When a “normal,” i.e., speech-signal-containing frame is received, customary decoding is performed. The bit rate for such a normal frame is typically 8 kbit/s or above. When an SID frame is received, comfort noise is synthesized, so that in the case of a wideband SID, wideband comfort noise is synthesized and distributed with a read-out gain factor.

Other embodiments include further details for inclusion of the DTX process in wideband codecs such as G.729.1, for example, and additional methods of modifying the TDBWE process, which support a synthesis of comfort noise during non-active frames, i.e., frames without speech information.

The following procedure is provided according to one embodiment.
Production of narrowband SID information for generation of a G.729- or G.729.B-compatible SID frame (first component LB of the SID frame according to the invention).
Production of wideband SID information using a modified TDBWE method (second component HB of the SID frame according to the invented method).
Enhancements in terms of the narrowband and/or wideband SID information are optionally made.
The background noise is analyzed or “acquired” in terms of energy and/or frequency distribution during a phase which precedes transmission of the first SID frame.
The SID frames are sent when a significant change in the wideband component of the background noise is detected or when an update of the narrowband SID information should be sent.

This embodiment example is implemented in the following phases:
An active speech pause or speaking pause is defined by means of a VAD method.
If a change in the speech pause is indicated by the VAD method, a hangover period is initiated. During the hangover period, the bit rate of the encoder is reduced to 14 kbit/s, if the previous bit rate identified was higher. If the previous bit rate of the encoder was already at 12 kbit/s, the bit rate is reduced to 8 kbit/s.
During the hangover period, the background noise is acquired in terms of the narrowband component in a similar form to the procedure in Standard G.729, but using a higher number of frames. A filtering process can be applied optionally at this juncture, through which it is achieved that the current frame is assigned a greater importance than the previous frame.
Moreover, the background noise in the wideband component is acquired during the hangover period. For simplified implementation, in particular to reduce the memory requirement, a modified TDBWE method can optionally be used, which is characterized by simplified encoding in the time period. An additional simplification can be optionally achieved in the modified TDBWE method by having the encoding in the time period correspond only to the energy of the signal in the time period. A further optional simplified encoding consists in applying spectral smoothing methods, because the energy in the time period and frequency range yields the same values when the Parseval theorem is applied. In the wideband component of the background noise as well, further optional filtering measures can be applied with the objective of assigning current frames a higher importance than previous frames.
After the conclusion of the hangover period, a first SID frame is sent which contains a rough representation of the background noise. The rough description of the background noise has been acquired during the hangover period.
As long as no active phase (speaking) has been detected by the VAD, a comfort noise on the decoder or receiver's end is synthesized on the basis of the received SID frame.
Changes in the background noise are detected in the narrowband component of the SID frame, in which a process similar to G.729 is followed, although different parameters are considered.
In the wideband component, filtered energy parameters are used for description of the background noise. These include, for example, parameters from envelope curves in the time period tenv fidx and/or parameters of envelope curves in the frequency range fenv_fidx [i], in which a respective Index idx identifies a respective frame and in which the envelope curve in the frequency range of a suitable number of frequency values i={1, . . . , NB-SUBBANDS} is generated to describe the spectral characteristics of the background noise. The filtered energy parameters are derived from those TDBWE parameters defined in G.729.1 by the use of suitable low-pass filters:

tenv_{—}f_{idx}==αₜₑₙᵥ·tenv_{idx}+(1−αₜₑₙᵥ)·tenv_{—}f_{idx-1}

fenv_{—}f_{idx}[i]=αₜₑₙᵥ·fenv_{idx}[i]+(1−αₜₑₙᵥ)·fenv_{—}f_{idx-1}[i]
Which are applied accordingly to the envelope parameters in the frequency range and time period.
Changes in the wideband component of the energy parameters are monitored and detected, while the filtered energy parameters of the present noise signal are compared with two sets of comparison values of these parameters, in which a set of comparison values is the parameters from the previous frame with the Index idx−1.

$$temp\_d = 20 \cdot \frac{log ( 2 )}{log ( 10 )} \cdot \vert {tenv\_f}_{idx} - {tenv\_f}_{idx - 1} \vert$$

$$spec\_d = 20 \cdot \frac{log ( 2 )}{log ( 10 )} \cdot \frac{1}{NB\_SUBBANDS} \cdot {\sum }_{i = 1}^{NB\_SUBBANDS} \vert {fenv\_f}_{idx} [ i ] - {fenv\_f}_{idx - 1} [ i ] \vert$$

And where another set consists of parameters from the most recently transmitted frame with the Index last tx. When one of the parameter differences (temp_d, spec_d, temp_ch, spec_ch) exceeds an appropriately selected threshold:

$$temp\_ch = 20 \cdot \frac{log ( 2 )}{log ( 10 )} \cdot \vert {tenv\_f}_{idx} - {tenv\_f}_{last\_tx} \vert$$

$$spec\_ch = 20 \cdot \frac{log ( 2 )}{log ( 10 )} \cdot \frac{1}{NB\_SUBBANDS} \cdot {\sum }_{i = 1}^{NB\_SUBBANDS} \vert {fenv\_f}_{idx} [ i ] - {fenv\_f}_{last\_tx} [ i ] \vert$$

a new SID update frame must be sent.
As soon as the VAD detects a speech period, the speech signal is transmitted at the required transmission rate and the synthesis of comfort noise ends on the side of the decoder. Therefore, a normal decoder mode is employed as in G.729.1.

1-7. (canceled)

8. A method for encoding a Silence Insertion Descriptor (SID) frame for transmission of background noise information using a scalable speech signal encoding method comprising:
receiving a speech signal;
deconstructing the speech signal into a first narrowband component, a second wideband component and a third enhanced narrowband component;
detecting a speech pause;
initiating a hangover period;
during the hangover period, reducing a bit rate of an encoder to a first pre-specified value;
acquiring background noise in the first narrowband component and the second wideband component and the third enhanced narrowband component during the hangover period;
analyzing the background noise during the hangover period based on energy of a noise signal of the background noise and a frequency distribution of the noise signal;
encoding a first SID frame via the encoder, the first SID frame encoded to comprise a description of the background noise acquired during the hangover period, the first SID frame having a first lowerband component and a second highband component and a third intermediate band component, the first lowerband component comprising background noise information of the acquired background noise of the first narrowband component encoded at a first bit rate and the second highband component comprising background noise information of the acquired background noise of the second wideband component encoded at a second bit rate that is higher than the first bit rate and the third intermediate band component comprising background noise information of the acquired background noise of the third enhanced narrowband component encoded at a third bit rate that is higher than the first bit rate and lower than the second bit rate, the first lowerband component, the second highband component, and the third intermediate band component are the only components of the first SID frame;
after conclusion of the hangover period, sending the first SID frame to a receiver side for decoding of that first SID frame; and
providing scalability for transmission of voice information corresponding to forming of the first SID frame such that the receiver side specifies whether comfort noise generation should occur based on at least one of: the first lowerband component of the first SID frame, the second highband component of the first SID frame, and the third intermediate band component of the first SID frame so that synthesized comfort noise is at a content quality that acoustically matches content quality of speech data included within the first SID frame.

9. The method of claim 8 comprising encoding the first lowerband component of the first SID frame according to Standard G.729.

10. The method of claim 8 comprising encoding the second highband component of the first SID frame according to a modified time domain bandwidth extension (TDBWE) method.

11. The method of claim 8 comprising during the hangover period, applying filtering methods assigning a higher importance to a current frame than a previous frame.

12. The method of claim 8 wherein the first lowerband component of the first SID frame has a first data length and the second highband component of the first SID frame has a second data length that is greater than the first data length.

13. The method of claim 12 wherein the third intermediate band component of the first SID frame also having a third data length, the third data length being lower than the first data length.

14. The method of claim 13 wherein the first bit rate is 8 kbit/s or lower than 8 kbit/s, the second bit rate is greater than or equal to 14 kbit/s and the third bit rate is greater than 8 kbit/s and less than 14 kbit/s and wherein the first data length is 15 bits, the second data length is 19 bits and the third data length is 9 bits.

15. The method of claim 13 wherein the first bit rate is 8 kbit/s or lower than 8 kbit/s and the second bit rate is between 14 kbit/s and 32 kbit/s.

16. The method of claim 15 further comprising receiving the first SID frame and synthesizing comfort noise based on the received first SID frame.

17. The method of claim 16 further comprising after detecting the speech pause, applying a filtration process to compare temporal and spectral parameters of the background noise from a previous frame to detect significant changes in the background noise.

18. The method of claim 17 wherein the second highband component of the first SID frame is configured such that filtered energy parameters describe the background noise for the second highband component of the first SID frame.

19. The method of claim 18 further comprising:
monitoring changes to the second wideband component of the background noise;
detecting that a change to the second wideband component of the background noise is above a predetermined threshold to determine that the background noise is changed;
encoding a second SID frame to describe the detected changed background noise.

20. The method of claim 19 wherein the second SID frame has a second highband component, the second highband component of the second SID frame comprising background noise information of the detected changed background noise of the second wideband component that is encoded at the second bit rate.

21. The method of claim 20 wherein after the first SID frame is sent, no further SID frame is sent until the change to the background noise that exceeds the predetermined threshold is detected.

22. The method of claim 8, wherein the second highband component identifies filtered energy parameters used to describe background noise.

23. The method of claim 8 wherein the first pre-specified value is 14 kbit/s when the encoder had a bit rate that was greater than 14 kbit/s prior to the hangover period and wherein the first pre-specified value is 8 kbit/s when the encoder had a bit rate that was less than or equal to 14 kbit/s prior to the hangover period.

24. A method for encoding a Silence Insertion Descriptor (SID) frame for transmission of background noise information using a scalable speech signal encoding method comprising:
receiving a speech signal;
deconstructing the speech signal into a first narrowband component, a second wideband component and a third enhanced narrowband component;
detecting a speech pause;
initiating a hangover period in response to the detected speech pause;
during the hangover period, reducing a bit rate of an encoder to a first pre-specified value;
acquiring background noise in the first narrowband component and the second wideband component and the third enhanced narrowband component during the hangover period;
encoding a first SID frame, the first SID frame encoded to comprise a description of the background noise acquired during the hangover period, the SID frame having a first lowerband component and a second highband component and a third intermediate band component, the first lowerband component comprising background noise information of the acquired background noise of the first narrowband component encoded at a first bit rate and the second highband component comprising background noise information of the acquired background noise of the second wideband component encoded at a second bit rate that is higher than the first bit rate and the third intermediate band component comprising background noise information of the acquired background noise of the third enhanced narrowband component encoded at a third bit rate that is higher than the first bit rate and lower than the second bit rate;
after conclusion of the hangover period, sending the first SID frame to a receiver side for decoding of that first SID frame; and
specifying, at the receiver side, whether comfort noise is to be synthesized to provide scalability for transmission of voice information corresponding to forming of the first SID frame, the receiver side specifying whether comfort noise should occur based on at least one of: (i) the first lowerband component of the first SID frame, (ii) the second highband component of the first SID frame, and (iii) the third intermediate band component of the first SID frame such that the receiver side specifies synthesizing of comfort noise so that the synthesized comfort noise is at a content quality that matches content quality of speech data included within the first SID frame to acoustically match quality of the synthesized comfort noise with quality of the speech data included within the first SID frame.

25. The method of claim 24 wherein the first pre-specified value is 14 kbit/s when the encoder had a bit rate that was greater than 14 kbit/s prior to the hangover period and wherein the first pre-specified value is 8 kbit/s when the encoder had a bit rate that was less than 14 kbit/s prior to the hangover period.

26. The method of claim 25 comprising:
analyzing the background noise during the hangover period based on energy of a noise signal of the background noise and a frequency distribution of the noise signal; and
during the hangover period, applying filtering methods assigning a higher importance to a current frame than a previous frame.

27. The method of claim 26 wherein the first lowerband component of the first SID frame has a first data length and the second highband component of the first SID frame has a second data length that is greater than the first data length and the third intermediate band component of the first SID frame also having a third data length, the third data length being lower than the first data length; and
wherein the first bit rate is 8 kbit/s or lower than 8 kbit/s, the second bit rate is greater than or equal to 14 kbit/s and the third bit rate is greater than 8 kbit/s and less than 14 kbit/s and wherein the first data length is 15 bits, the second data length is 19 bits and the third data length is 9 bits.
